(19) United States
(12) Patent Application Publication
(10) Pub. No.: US 2013/0142120 A1
(43) Pub. Date: Jun. 6, 2013

(54) MOBILE COMMUNICATION METHOD AND CALL SESSION CONTROL SERVER DEVICE

(71) Applicants: Katsutoshi Nishida, Chiyoda-ku (JP); Keisuke Suzuki, Chiyoda-ku (JP)

(72) Inventors: Katsutoshi Nishida, Chiyoda-ku (JP); Keisuke Suzuki, Chiyoda-ku (JP)

(73) Assignee: NTT DOCOMO, INC., Tokyo (JP)

(21) Appl. No.: 13/703,917

(22) PCT Filed: Jun. 13, 2011
(86) PCT No.: PCT/JP2011/063450

§ 371 Date: Feb. 21, 2013

(30) Foreign Application Priority Data
Jun. 16, 2010 (JP) 2010-137781

(51) Int. Cl. H04W 60/04

(52) U.S. Cl. CPC H04W 60/04
USPC 370/328

(57) ABSTRACT

A mobile communication method according to the present invention includes the steps of: causing an MME to restart with a bearer for a UE established between an S-GW and a P-GW; causing a P/S-CSCF to transmit a terminating signal addressed to the UE to the S-GW via the P-GW; causing the S-GW to notify the P/S-CSCF via the P-GW that the MME has restarted; causing the P/S-CSCF to hold the terminating signal addressed to the UE; and causing the P/S-CSCF to transmit the terminating signal addressed to the UE to the S-GW via the P-GW after the UE is registered with an IMS again.

### TECHNICAL FIELD

The present invention relates to a mobile communication method and a call session control server device.

### BACKGROUND ART

In 3GPP, a method for performing a termination process for a UE (User Equipment) via an IMS (IP Multimedia Subsystem) is specified.

### PRIOR ART DOCUMENT

### Non-Patent Document

### Non-Patent Document 1: 3GPP TS23.228 Section 5.10.3.0

### SUMMARY OF THE INVENTION

### Problems to be Solved by the Invention

However, the applicant has discovered that the following problem occurs in such a method. In the following, the problem of such a method will be described with reference to FIG. 3.

As shown in FIG. 3, if there is an incoming signal addressed to a UE in Idle state in which registration with an IMS is complete after restart of an MME which once stops due to a fault and the like, with a bearer for the UE established between an S-GW (a Serving Gateway) and a P-GW (a Packet Data Network Gateway), a P/S-CSCF (a Proxy/Serving-Call Session Control Function) transmits a packet addressed to the UE to the P-GW in Step S5001 and the P-GW transmits such a packet to the S-GW in Step S5002. It is assumed that such a packet contains “INVITE” addressed to the UE.

In Step S5003, the S-GW transmits “Downlink Data Notification” to the MME.

In Step S5004, the MME transmits “Downlink Data Notification Ack” notifying the S-GW of an error, because context information on the UE has been deleted due to the restart.

Upon receipt of such “Downlink Data Notification Ack”, the S-GW releases the bearer for the UE mentioned above in Step S5005.

Then, in Step S5006, P/S-CSCF retransmits the packet addressed to the UE to the P-GW, and the P-GW retransmits such a packet to the S-GW in Step S5007.

Since the S-GW has released the bearer for the UE mentioned above, it discards such a packet in Step S5008 and transmits “GTP-U Error Indication” to the P-GW in Step S5009.

In Step S5010, upon receipt of such “GTP-U Error Indication”, the P-GW releases the bearer for the UE mentioned above.

Then, in Step S5011, the P/S-CSCF retransmits the packet addressed to the UE to the P-GW.

Since the P-GW has released the bearer for the UE mentioned above, it discards such a packet in Step S5012.

In Step S5013, in response to the event that the P-GW notifies a PCRF (a Policy and Charger Rule Function) of the P-GW having released the bearer for the UE, IMS Registration for such a UE is released between the PCRF and the P/S-CSCF.

As such, there is a problem in the conventional method that since a recovery process cannot be performed automatically when there is an incoming signal addressed to a UE via an IMS after restart of an MME which once stops due to a fault and the like, such a termination process fails and an originating user is notified of a call loss.

Hence, the present invention has been made in view of the problem described above, and an object of the present invention is to provide a mobile communication method and a call session control server device capable of not only automatically performing a recovery process but also connecting a call (i.e. , not causing a call loss) with an origination request signal transmitted by an originating user, when there is an incoming signal addressed to a UE via an IMS after restart of an MME which once stops due to a fault and the like.

### Means for Solving the Problem

A first characteristic of the present invention is a mobile communication method including the steps of causing a mobility management node to restart with a bearer for a mobile station established between a serving gateway device and a packet data network gateway device, causing a call session control server device to transmit a terminating signal addressed to the mobile station to the serving gateway device via the packet data network gateway device, causing the serving gateway device to notify the call session control server device via the packet data network gateway device that the mobility management node has restarted, causing the call session control server to hold the terminating signal addressed to the mobile station, and causing the call session control server device to transmit the held terminating signal addressed to the mobile station to the serving gateway device via the packet data network gateway device, after the mobile station is registered again.

The second characteristic of the present invention is a call session control server device wherein the call session control server device is configured to transmit a terminating signal addressed to a mobile station to a serving gateway device via a packet data network gateway device when receiving the terminating signal addressed to the mobile station after a mobility management node restarts with a bearer for the mobile station established between the serving gateway device and the packet data network gateway device, the call session control server device is configured to hold the terminating signal addressed to the mobile station when the call session control server device is notified by the serving gateway device that the mobility management node has restarted, and the call session control server device is configured to transmit the held terminating signal addressed to the mobile station to the serving gateway deice via the packet data network gateway device, after the mobile station is registered again.

### Effect of the Invention

As described above, according to the present invention, a mobile communication method and a call session control server device can be provided which can not only automatically perform a recovery process but also connect a call (i.e., not causing call loss) with an origination request signal transmitted by an originating user, when there is an incoming signal addressed to a UE via an IMS after restart of an MME which once stops due to a fault and the like.

### BRIEF DESCRIPTION OF THE DRAWINGS

FIG. 1 is an overall configurational view of a mobile communication system according to a first embodiment of the present invention.

FIG. 2 is a sequence diagram describing operations of the mobile communication system according to the first embodiment of the present invention.

FIG. 3 is a sequence diagram describing operations of a conventional mobile communication system.

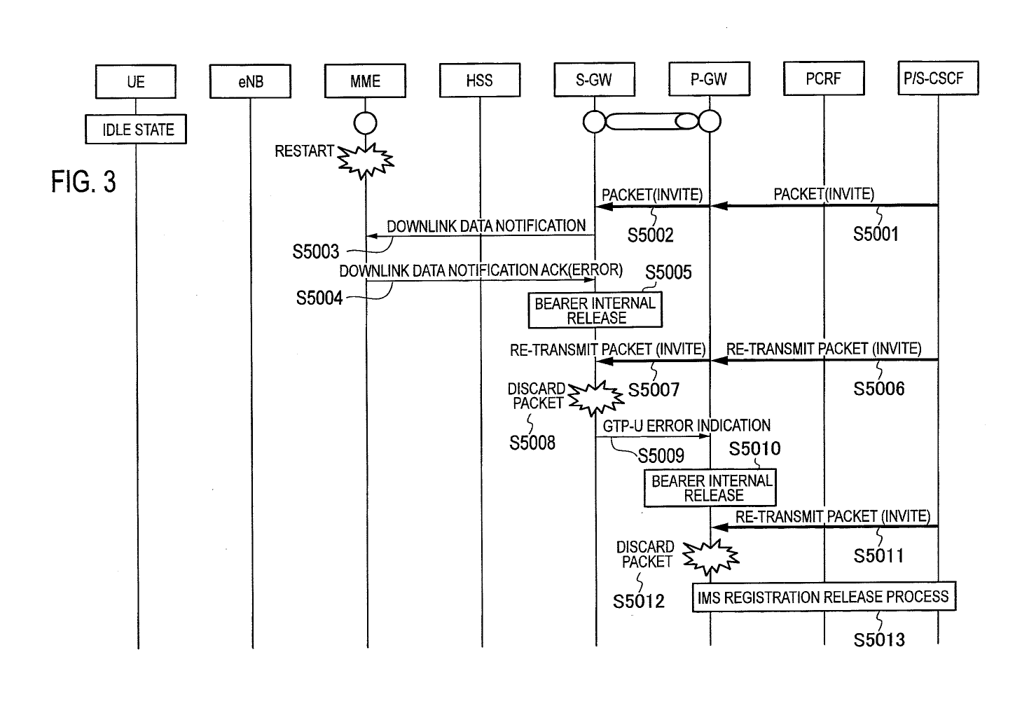

### MODES FOR CARRYING OUT THE INVENTION

(Mobile communication system according to a first embodiment of the present invention)

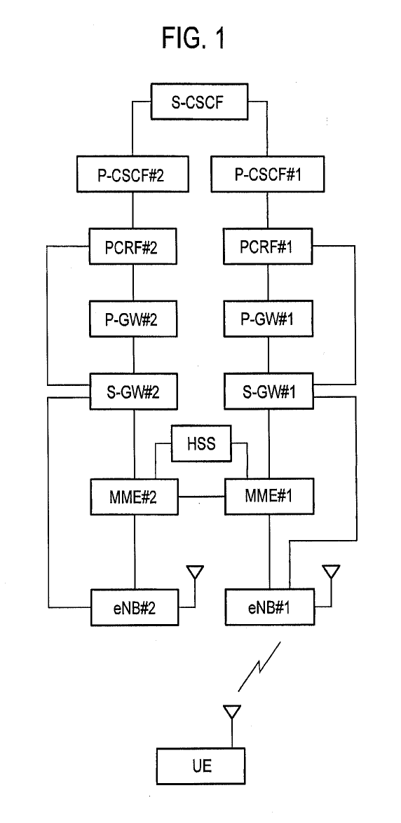

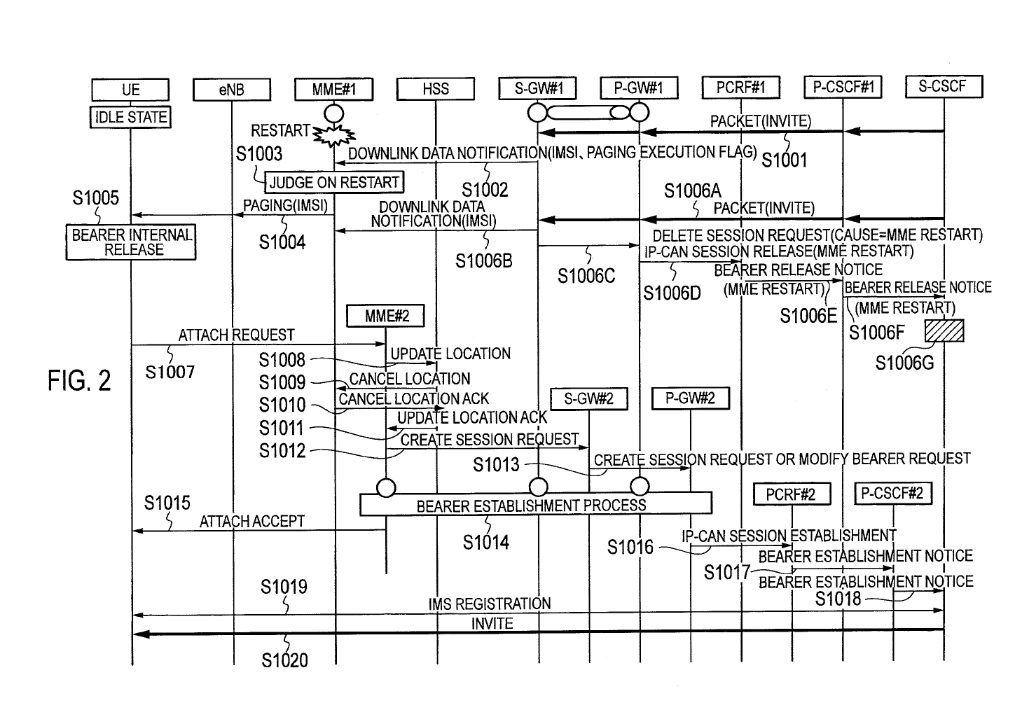

A mobile communication system according to a first embodiment of the present invention will be described with reference to FIG. 1 and FIG. 2.

As shown in FIG. 1, the mobile communication system according to the embodiment includes an S-CSCF (Serving-Call Session Control Function), P-CSCF (Proxy-Call Session Control Function) #1, P-CSCF#2, PCRF#1, PCRF#2, P-GW#1, P-GW#2, S-GW#1, S-GW#2, MME (Mobility Management Entity) #1, MME#2, eNB#1, eNB#2, and HSS (Home Subscriber Server).

In the following, with reference to FIG. 2, operations when there is an incoming signal addressed to a UE in Idle state in which registration with an IMS is complete after restart of the MME#1 which once stops due to a fault and the like, in the mobile communication system according to the embodiment will be described.

As shown in FIG. 2, if there is an incoming signal addressed to the UE in Idle state in which registration with the IMS is complete after restart of the MME#1 which once stops due to a fault and the like with a bearer for the UE established between the S-GW#1 and the P-GW#1, in Step S1001, the S-CSCF transmits a packet addressed to the UE to the P-CSCF#1, the P-CSCF#1 transmits the packet addressed to the UE to the P-GW#1, and the P-GW#1 transmits the packet addressed to the UE to the S-GW#1. It is assumed that such a packet contains “INVITE” addressed to the UE.

In Step S1002, upon receipt of the packet addressed to the UE, the S-GW#1 judges whether or not to transmit such a packet to a specific bearer.

For example, a bearer whose QCI (Quality of service Class Identifier) is “5” and the like is assumed as a specific bearer.

Here, if the S-GW#1 judges that such a packet should be transmitted to the specific bearer, it transmits to the MME#1 “Downlink Data Notification” containing IMSI (International Mobile Subscriber Identity) of the UE and “Paging execution flag”.

Here, the S-GW#1 may notify the MME#1 of whether or not transmission of “Paging” is needed, by setting or not setting the IMSI of UE, rather than “Paging execution flag”.

Note that when receiving the packet in Step S1002, the S-GW#1 does not release context information on the bearer for the UE which it has retained, even if the S-GW#1 has learned that the MME#1 restarted, from a GTP signal (restart information) and the like which it received before Step S1002.

On the one hand, if the S-GW#1 judges that such a packet should not be transmitted to the specific bearer, it discards the received packet. In such a case, the S-GW#1 may release the bearer associated with the received packet. In addition, the S-GW#1 may transmit to the P-GW#1 “Delete Session Request” requesting deletion of such a bearer.

Note that the S-GW#1 may transmit “Delete Session Request” in Step S1006C when a predetermined time elapses after it performed the process in Step S1002 or transmit “Delete Session Request” in Step S1006C immediately after performing the process in Step S1002.

In Step S1003, if the MME#1 receives such “Downlink Data Notification” in Step S1003, it judges whether or not context information of a UE identified by such IMSI is managed.

Here, if the MME#1 judges that the context information of the UE identified by such IMSI is not managed and that the received “Downlink Data Notification” contains the “Paging execution flag”, the MME#1 transmits “Paging” to the UE in Step S1004.

Here, instead of the “Paging execution flag”, the MME#1 may judge whether or not transmission of the “Paging” is needed, by setting or not setting the IMSI of the UE.

Upon receipt of the “Paging” addressed to the UE, the UE not only releases the bearer for the UE mentioned above in Step S1005 but also transmits “Attach Request” to the MME#2 in Step S1007.

On the one hand, in Step S1006A, the S-CSCF retransmits the packet addressed to the UE to the P-CSCF#1, the P-CSCF#1 retransmits the packet addressed to the UE to the P-GW#1, and the P-GW#1 retransmits the packet addressed to the UE to the S-GW#1.

If the S-GW#1 retains the context information on the bearer for the UE, upon receipt of the retransmitted packet addressed to the UE in Step S1006, the S-GW#1 may transmit to the MME#1 “Downlink Data Notification” containing the IMSI of the UE.

Alternatively, in such a case, the S-GW#1 may judge that the “Paging” addressed to the UE has been transmitted, and discard the retransmitted packet addressed to the UE.

Upon receipt of the “Downlink Data Notification” in Step S1006B, the MME#1 may retransmit the “Paging” addressed to the UE, similar to Step S1004.

Alternatively, in such a case, the MME#1 may judge that the “Paging” addressed to the UE has been transmitted, and discard the received “Downlink Data Notification”.

On the one hand, when a predetermined time elapses after the S-GW#1 performs the process in Step S1002, the S-GW#1 transmits “Delete Session Request” containing “Cause=MME restart (information indicating that the MME#1 has restarted)” to the P-GW#1 in Step S1006C.

Upon receipt of such “Delete Session Request”, the P-GW#1 releases the above-mentioned bearer for the UE and transmits “IP-CAN Session Release” containing “MME restart (information indicating that the MME#1 has restarted)” to the PCRF#1 in Step S1006D.

Upon receipt of such “IP-CAN Session Release”, the PCRF#1 releases the context information of the above-mentioned UE and transmits a bearer release notice containing the “MME restart (the information indicating that the MME#1 has restarted)” to the P-CSCF#1 in Step S1006E.

Upon receipt of such a bearer release notice, the P-CSCF#1 transmits the bearer release notice containing the “MME restart (the information indicating that the MME#1 has restarted)” to the S-CSCF in Step S1006F.

Upon receipt of such a bearer release notice, the S-CSCF holds a packet addressed to the UE mentioned above in Step S1006. In such a case, if the packet transmitted in Step S1001 is being retransmitted, the S-CSCF also holds such a packet.

In Step S1008, the MME#2 transmits to the HSS “Update Location” containing identification information of the UE.

Upon receipt of such “Update Location”, the HSS transmits “Cancel Location” to the MME#1 in Step S1009.

Upon receipt of such “Cancel Location”, the MME#1 transmits “Cancel Location Ack” to the HSS in Step S1010.

Upon receipt of the “Cancel Location Ack”, the HSS changes position registration information of the UE and transmits “Update Location Ack” to the MME#2 in Step S1011.

In Step S1012, the MME#1 transmits “Create Session Request” containing a restart counter (information indicating that the MME#1 has restarted) to the S-GW#2. Note that the restart counter may not be set.

Upon receipt of such “Create Session Request”, the S-GW#2 sets the bearer for the UE mentioned above and transmits “Create Session Request” containing a MME restart flag (the information indicating that the MME#1 has restarted) to the P-GW#2.

Upon receipt of such “Create Session Request”, the P-GW#2 sets the bearer for the UE mentioned above.

In Step S1014, a process for establishment the bearer for the UE continues among the MME#2, HSS, S-GW#2, and P-GW#2.

In Step S1015, the MME#2 transmits “Attach Accept” to the UE.

On the one hand, upon receipt of the “Create Session Request” in Step S1013, the P-GW#2 transmits “IP-CAN Session Establishment” to the PCRF#2 in Step S1016, the PCRF#2 transmits a bearer establishment notice to the P-CSCF#2 in Step S1017, and the P-CSCF#2 transmits the bearer establishment notice to the S-CSCF in Step S1018.

On the one hand, when the UE receives the “Attach Accept” in Step S1015, the UE performs “IMS Registration process” on the P-CSCF#2 and the S-CSCF in Step S1019. Note that the P-CSCF#2 is same as the P-CSCF#1.

Then, in Step S1020, the S-CSCF detects that the UE has established a connection again, and sends the UE the held packet addressed to the UE via the P-GW#2 and the S-GW#2.

In addition, if the S-GW#2 is same as the S-GW#1, and setting is such that the S-GW#1 which transmits “Delete Session Request” in Step S1002 continues to hold a bearer for a UE even after a certain time elapses, in Step S1013, the P-GW#2 does not release the bearer for the UE mentioned above when it receives “Create Session Request”. The S-CSCF may transmit “Modify Bearer Request” containing the MME restart flag (the information indicating that the MME#1 has restarted) to the P-GW#1 in Step S1014.

In such a case, upon receipt of such “Modify Bearer Request”, the P-GW#1 does not release the above-mentioned bearer for the UE and reuses the bearer for such a UE.

With the mobile communication system according to the embodiment, since the S-CSCF is configured to hold a packet addressed to a UE when receiving a bearer release notice, a termination process addressed to such a UE can be performed promptly, when there is an incoming signal addressed to a UE in Idle state in which registration with the IMS is complete after restart of the MME which once stops due to a fault and the like.

Note that PMIPv6 (Proxy Mobile IP v6) protocol may be applied to a section between the S-GW and P-GW.

In such a case, the PCRF may receive the MME restart flag indicating that the MME#1 has restarted, with either the S-GW or the P-GW.

In the former case, such an MME restart flag is notified to the P-GW through a PCC process in a section between the S-GW and the PCRF and the section between the PCRF and the P-GW.

In the latter case, the above-mentioned MME restart flag is notified to the P-GW with “Proxy Binding Update” of a PMIPv6 signal.

### (Modification 1)

In the following, a mobile communication system according to Modification 1 of the first embodiment described above will be described with a focus on differences from the mobile communication system according to the first embodiment described above.

In the example of FIG. 2, although a case in which a UE transmits “Attach Request” to an MME#2 in Step S1007 is described, the present invention will also be applicable to a case in which the UE transmits the “Attach Request” to an MME#1 in Step S1007.

In the latter case, upon receipt of the “Attach Request” from the UE, the MME#1 transmits “Create Session Request” containing a restart counter (information indicating that the MME#1 has restarted) to an S-GW#1.

Upon receipt of such “Create Session Request”, the S-GW#1 not only releases a bearer for the UE mentioned above but also transmits to the P-GW#1 “Create Session Request” containing the MME restart flag (the information indicating that the MME#1 has restarted).

Then, upon receipt of such “Create Session Request”, the P-GW#1 not only releases the bearer for the UE mentioned above but also transmits “IP-CAN Session Establishment” to a PCRF#1.

Upon receipt of such “IP-CAN Session Establishment”, the PCRF#1 releases the bearer for the UE mentioned above and transmits a bearer establishment notice to a P-CSCF#2.

Upon receipt of such a bearer establishment notice, the P-CSCF#1 transmits the bearer establishment notice to an S-CSCF.

The characteristics of the embodiment described above may be represented as follows.

A first characteristic of the embodiment is a mobile communication method, and is summarized in that the method includes the steps of: causing an MME (a mobility management node) to restart with a bearer for a UE (a mobile station) established between an S-GW (a serving gateway device) and a P-GW (a packet data network gateway device); causing a P/S-CSCF (a call session control server device) to transmit a terminating signal addressed to the UE to the S-GW via the P-GW; causing the S-GW to notify the P/S-CSCF via the P-GW that the MME has restarted; causing the P/S-CSCF to hold the terminating signal addressed to the UE; and causing the P/S-CSCF to transmit the held terminating signal addressed to the UE to the S-GW via the P-GW after the UE is registered with the INS again.

In the first characteristic of the embodiment, the S-CSCF may hold the terminating signal addressed to the UE mentioned above.

A second characteristic of the embodiment is a P/S-CSCF, and is summarized in that the P/S-CSCF is configured to transmit a terminating signal addressed to a UE to an S-GW via a P-GW when receiving the terminating signal addressed to the UE after an MME restarts with a bearer for the UE established between the S-GW and the P-GW; the P/S-CSCF is configured to hold the terminating signal addressed to the UE station when the P/S-CSCF is notified by the S-GW that the MME has restarted; and the P/S-CSCF is configured to transmit the held terminating signal addressed to the UE to the S-GW via the P-GW after the UE is registered with the INS again.

Note that operations of the MME#1, MME#2, S-GW#1, S-GW#2, P-GW#1, P-GW#2, PCRF#1, PCRF#2, P-CSCF#1, P-CSCF#2, S-CSCF, eNB#1, eNB#2, and UE described above may be performed by hardware, may be performed by a software module executed by a processor, or may be performed by a combination of both.

The software module may be provided in any type of storage medium such as a RAM (Random Access Memory), flash memory, ROM (Read Only Memory), EPROM (Erasable Programmable ROM), EEPROM (Electronically Erasable and Programmable ROM), register, hard disk, removal disk, or CD-ROM.

Such a storage medium is connected to a processor so that the processor can read and write information from and to the storage medium. In addition, such a storage medium may be integrated in a processor. In addition, such a storage medium and processor may be provided in an ASIC. Such an ASIC may be provided in an MME#1, MME#2, S-GW#1, S-GW#2, P-GW#1, P-GW#2, PCRF#1, PCRF#2, P-CSCF#1, P-CSCF#2, S-CSCF, eNB#1, eNB#2, or UE. In addition, such a storage medium and processor may be provided in an MME#1, MME#2, S-GW#1, S-GW#2, P-GW#1, P-GW#2, PCRF#1, PCRF#2, P-CSCF#1, P-CSCF#2, S-CSCF, eNB#1, eNB#2, or UE as discrete component.

Although the present invention has been described so far in detail with the embodiments described above, it is apparent to those skilled in the art that the present invention is not limited to the embodiments described herein. The present invention can be carried out as a modification or alteration without departing from the intent and scope of the present invention to be defined by a description of the claims. Therefore, the description of the specification is intended to provide an exemplary description and does not have any limiting sense to the present invention.

1. A mobile communication method comprising the steps of:
causing a mobility management node to restart with a bearer for a mobile station established between a serving gateway device and a packet data network gateway device;
causing a call session control server device to transmit a terminating signal addressed to the mobile station to the serving gateway device via the packet data network gateway device;
causing the serving gateway device to notify the call session control server device via the packet data network gateway device that the mobility management node has restarted;
causing the call session control server to hold the terminating signal addressed to the mobile station; and
causing the call session control server device to transmit the held terminating signal addressed to the mobile station to the serving gateway device via the packet data network gateway device, after the mobile station is registered again.

2. The mobile communication method according to claim 1, wherein
the call session control server device includes a proxy call session control server device and a serving call session control server, and
the serving call session control server device holds a terminating signal addressed to the mobile station.

3. A call session control server device wherein
the call session control server device is configured to transmit a terminating signal addressed to a mobile station to a serving gateway device via a packet data network gateway device when receiving the terminating signal addressed to the mobile station after a mobility management node restarts with a bearer for the mobile station established between the serving gateway device and the packet data network gateway device;
the call session control server device is configured to hold the terminating signal addressed to the mobile station when the call session control server device is notified by the serving gateway device that the mobility management node has restarted; and
the call session control server device is configured to transmit the held terminating signal addressed to the mobile station to the serving gateway deice via the packet data network gateway device, after the mobile station is registered again.
